(19) United States
(12) Patent Application Publication
(10) Pub. No.: US 2014/0265740 A1
(43) Pub. Date: Sep. 18, 2014

(54) ACCELEROMETER

(71) Applicant: Nuovo Pignone S.p.A., Florence (IT)

(72) Inventor: Fabrizio Franci, Firenze (IT)

(21) Appl. No.: 14/351,486

(22) PCT Filed: Oct. 9, 2012
(86) PCT No.: PCT/EP2012/069975

§ 371 Date: Apr. 11, 2014

(30) Foreign Application Priority Data
Oct. 13, 2011 (IT) CO2011A000042

(51) Int. Cl. G01P 15/09; H02K 11/00

(52) U.S. Cl. CPC G01P 15/09; H02K 11/001
USPC 310/68 B; 73/514.34; 29/25.35

(57) ABSTRACT

An accelerometer including a metal housing and at least one of an integrated piezoelectric sensor and an integrated electronic piezoelectric (IEPE) amplified sensor within the housing. A metal boot extends from the housing and a plurality of sensor wires extends from the sensor into the boot. The accelerometer also includes a metal cable sheath connected to the boot having a plurality of cable wires insulated by a metal oxide powder contained by the sheath. At least one of the plurality of sensor wires is connected to at least one of the plurality of cable wires within the boot. The housing, the boot, and the metal cable sheath provide a sealed enclosure for the at least one sensor, the plurality of sensor wires and the plurality of cable wires.

### BACKGROUND OF THE INVENTION

Embodiments of the subject matter disclosed herein generally relate to transducers and more particularly, to an accelerometer capable of use in a harsh environment.

During the past years, with the increase in price of fossil fuels, the interest in many aspects related to the processing of fossil fuels has increased. During processing of fossil fuels, fluids are transported from on-shore or offshore locations to processing plants for subsequent use. In other applications, fluids may be transported more locally, for example, between sub-systems of a hydrocarbon processing plant to facilitate distribution to end-users.

At least some fluid transport stations use rotary machines, such as compressors, fans and/or pumps that are driven by gas turbines. Some of these turbines drive the associated fluid transport apparatus via a gearbox that either increases or decreases a gas turbine output drive shaft speed to a predetermined apparatus drive shaft speed. In other rotary machines, electrically-powered drive motors, or electric drives are used in place of (or in conjunction) with mechanical drives (i.e., gas turbines) to operate the rotary machine.

One turbomachine often used in the industry includes a compressor driven by an electrical motor. Such a turbomachine may be employed, e.g., for recovering methane, natural gas, and/or liquefied natural gas (LNG). The recovery of such gasses may reduce emissions and reduce flare operations during the loading of LNG onto ships. Other uses of this kind of turbomachine are known in the art and not discussed here.

An example of such a rotary machine is shown in FIG. 7. Rotary machine 502 includes an electrical motor 504 connected to a compressor 506. The connection between the two machine shafts can be achieved by a mechanical joint 508. The motor external casing 510 may be attached to the compressor external casing 512 by, for example, bolts 514. The compressor 506 may include one or more impellers 516 attached to a compressor shaft 518. The compressor shaft 518 is configured to rotate around a longitudinal axis X. The rotation of the compressor shaft 518 is enhanced by using active magnetic bearings 520 and 522 at both ends of the compressor shaft 518.

Regardless of the particular setting, i.e. on-shore, offshore, subsea, etc. and regardless of whether the rotary machine is turbine or motor driven, there is an ever present need to increase the efficiency, decrease the costs, and reduce the environmental impact of fossil fuel processing, and in particular, of rotary machines involved in such processing.

As a result of this ever present need, the performance of rotary machines continues to improve. Today's rotary machines are not only more efficient and environmentally friendly, they are capable of processing more corrosive substances at higher temperatures and higher pressures than ever before.

While these improvements are welcome, existing solutions for controlling these processes are oftentimes inadequate to meet the demands of working in the harsh environments brought about by such improvements.

One area of particular concern is transducers. Transducers play a vital role in providing information about not only the processes performed by rotary machines, but also about the rotary machines themselves. Some transducers, such as accelerometers may be used not only to gain insight about the efficiency of the process being performed by the rotary machine but also about the health of a component of the rotary machine itself, such as a bearing, or a shaft.

The placement of the accelerometer relative to the location where process information and/or machine information is being created is important to the capability of the accelerometer to measure such information. Oftentimes this requires locating the accelerometer proximate to the point where such information is created, for example, within the rotary machine.

Such a location may be in a particularly harsh environment, for example, in or proximate to high pressure, high temperature, and/or corrosive process fluids. With regard to the above-discussed rotary machine 502 in FIG. 7, note that the magnetic bearings 520 and 522 are exposed to the fluid being processed by the compressor. This fluid, for example, methane, may be corrosive and is likely to have a high pressure, for example, 2000 psi, and temperature, for example, 160 degrees Celsius. Moreover, a particularly strong electromagnetic field may be presented by active magnetic bearings 520 and 522. It is desirous to position one or more accelerometers, and/or other transducers, proximate to bearing 520 and/or bearing 522 within rotary machine 502. Accordingly, there is a need for a transducer, and particularly, an accelerometer which may successfully operate within such an environment.

### SUMMARY OF THE INVENTION

According to an exemplary embodiment an accelerometer (or acceleration transducer) includes a metal housing and at least one of an integrated piezoelectric acceleration sensor and an integrated electronic piezoelectric (IEPE) amplified acceleration sensor within the housing. A metal boot extends from the housing and a plurality of sensor wires extends from the sensor into the boot. The accelerometer also includes a metal cable sheath connected to the boot having a plurality of cable wires insulated by a metal oxide powder contained by the sheath. At least one of the plurality of sensor wires is connected to at least one of the plurality of cable wires within the boot. The housing, the boot, and the metal cable sheath provide a sealed enclosure for the at least one sensor, the plurality of sensor wires and the plurality of cable wires.

According to another embodiment a transducer assembly for a rotary machine includes a housing positioned proximately of a bearing within the rotary machine and a metal sheath connected to the housing to form a sealed enclosure. A transducer is within the housing and at least one wire extending from the metal sheath is electrically connected to the transducer. A metal oxide powder contained by the sheath insulates the at least one wire.

According to another embodiment a method of providing a sealed enclosure for an acceleration transducer (or accelerometer) includes providing a metal housing with a metal boot extension, positioning at least one of an integrated piezoelectric acceleration sensor and an integrated electronic piezoelectric (IEPE) amplified acceleration sensor within the housing such that a plurality of wires extending from the at least one sensor extend out of the metal boot extension, positioning a metal sheath having a plurality of wires insulated by a metal oxide powder such that the wires extend from an end of the sheath to the wires extending from the sensor, electrically connecting the plurality of wires extending from the at least one sensor to the plurality of wires extending from the boot and positioning the electrically connected wires within the metal boot extension, and connecting the metal sheath to the boot thereby providing a sealed enclosure for the at least one sensor, the plurality of sensor wires and the plurality of cable wires.

The various features of novelty which characterize the invention are pointed out with particularity in the claims annexed to and forming a part of this disclosure. For a better understanding of the invention, its operating advantages and benefits obtained by its uses, reference is made to the accompanying drawings and descriptive matter. The accompanying drawings are intended to show examples of the many forms of the invention. The drawings are not intended as showing the limits of all of the ways the invention can be made and used. Changes to and substitutions of the various components of the invention can of course be made. The invention resides as well in sub-combinations and sub-systems of the elements described, and in methods of using them.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a perspective view of an exemplary embodiment.

FIG. 2 is a side view of the exemplary embodiment shown in FIG. 1.

FIG. 3 is a cross-sectional view of a metal cable sheath according to an exemplary embodiment.

FIG. 4 is an end view of the exemplary embodiment shown in FIG. 3.

FIG. 5 is a cross-sectional view of a boot according to another exemplary embodiment.

FIG. 6 is a flowchart of a method according to an exemplary embodiment.

FIG. 7 depicts a rotary machine.

### DETAILED DESCRIPTION OF THE EXEMPLARY EMBODIMENTS OF THE INVENTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of a transducer that has a housing and a sensor. However, the embodiments to be discussed next are not limited to these exemplary systems, but may be applied to other systems.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

FIGS. 1 and 2 show an exemplary embodiment of an accelerometer 14 according to an embodiment of the present invention. Accelerometer 14 includes a metal housing 16 having a first side 18 (FIG. 1) and a second side 22 (FIG. 2) defining a pentagon shape. Pentagon shaped housing 16 is symmetrical about a plane defined by the intersection of sides 28 and 32 and the center of side 24.

Housing 16 also includes sides 24, 26, 28, 32, and 34 which extend between the edges of first and second sides 18, 22. As shown in FIGS. 1 and 2, sides 24, 26, 28, 32, and 34 have equal widths.

A sensor (not shown) which is capable of sensing an acceleration along at least one axis and generating a signal corresponding to the sensed acceleration is provided within housing 16. In the embodiment shown in FIGS. 1 and 2, the transducer is a three axis accelerometer transducer. Exemplary three axis accelerometer sensors include integrated piezoelectric sensors and integrated electronic piezoelectric (IEPE) amplified sensors.

Accelerometer 14 also includes a metal boot 36 extending from side 24 of housing 16. As shown in FIGS. 1, 2 and 5 metal boot 36 is a cylindrical tube connected to side 24 of housing 16 by a weld 38. However, this connection may be formed by other chemical means such as an adhesive sealant and/or mechanical means such as a threaded connection. Alternatively, housing 16 and boot 36 may be integrally formed.

As further shown in FIGS. 1, 2 and 5, a metal cable sheath 38 is connected to boot 36. Metal sheath 38 is connected to boot 36 with an epoxy sealant 40. However, this connection may be formed by other chemical means such as a weld and/or mechanical means such as a threaded connection. Alternatively, metal sheath 38 and boot 36 may be integrally formed.

Metal cable sheath 38 is provided with four wires 42, 44, 46, and 48. Wires 42, 44, and 46, each correspond to an axis of acceleration and wire 48 is a common wire. Wires 42, 44, 46 and 48 are insulated by a metal oxide powder 52, for example, magnesium oxide powder and/or silicon oxide powder, contained by metal sheath 38.

As shown in FIG. 5, four transducer wires 54, 56, 58, and 62 extend into boot 36 from the accelerometer transducer within housing 16. Wires 54, 56, and 58 each correspond to an axis of acceleration and wire 62 is a common wire.

Wires 42 and 54, wires 44 and 56, wires 46 and 58, and wires 48 and 62 are electrically connected at joints 64, 66, 68, and 72, for example, by laser soldering. Non-conductive sealant 74 may be provided between the wires and the solder joints within boot 36.

As may be appreciated from FIG. 1-5, metal housing 16, metal boot 36, and metal cable sheath 38 provide a sealed enclosure for the transducer, wires, and solder joints. Further, metal oxide insulating material within cable sheath 38 is also made from metal. Accordingly, accelerometer 16 is capable of withstanding corrosion, higher pressures, higher temperatures, and stronger electromagnetic fields than conventional accelerometers.

According to an embodiment as shown in the flowchart of FIG. 6, a method (1000) of providing a sealed enclosure for an accelerometer can include providing (1002) a metal housing with a metal boot extension, positioning (1004) at least one of an integrated piezoelectric acceleration sensor and an integrated electronic piezoelectric (IEPE) amplified acceleration sensor within the housing such that a plurality of wires extending from the at least one sensor extend out of the metal boot extension, positioning (1006) a metal sheath having a plurality of wires insulated by a metal oxide powder such that the wires extend from an end of the sheath to the wires extending from the sensor, electrically connecting (1008) the plurality of wires extending from the at least one sensor to the plurality of wires extending from the boot, positioning (1010) the electrically connected wires within the metal boot extension, connecting (1012) the metal sheath to the boot thereby providing a sealed enclosure for the at least one sensor, the plurality of sensor wires and the plurality of cable wires.

The above-described embodiments are intended to be illustrative in all respects, rather than restrictive, of the present invention. All such variations and modifications are considered to be within the scope and spirit of the present invention as defined by the following claims. No element, act, or instruction used in the description of the present application should be construed as critical or essential to the invention unless explicitly described as such. Also, as used herein, the article “a” is intended to include one or more items.

The written description uses examples to disclosure the invention, including the best mode, and also to enable any person skilled in the art to practice the invention, including making and using any devices or systems and performing any incorporated processes. The patentable scope of the invention is defined by the claims, and may include other examples that occur to those skilled in the art. These other examples are intended to be within the scope of the claims if they have structural elements that do not differ from the literal language of the claims, or if they include equivalent structural elements with insubstantial differences from the literal languages of the claims.

What is claimed is:

1. An accelerometer, the accelerometer comprising:
a metal housing;
at least one of an integrated piezoelectric accelerometer sensor and an integrated electronic piezoelectric (IEPE) amplified accelerometer sensor within the housing;
a metal boot extending from the housing;
a plurality of sensor wires extending from the sensor into the boot;
a metal cable sheath connected to the boot and having a plurality of cable wires insulated by a metal oxide powder contained by the sheath; and
at least one of the plurality of sensor wires being connected to at least one of the plurality of cable wires within the boot,
wherein the housing, the boot, and the metal cable sheath provide a sealed metal enclosure for the at least one sensor, the plurality of sensor wires and the plurality of cable wires.

2. The accelerometer of claim 1, wherein the plurality of cable wires comprise four wires.

3. The accelerometer of claim 1, wherein the plurality of sensor wires comprise four wires, a first sensor wire carrying a signal corresponding to a first axis, a second sensor wire carrying a signal corresponding to a second axis, a third sensor wire carrying a signal corresponding to a third axis and a fourth sensor wire corresponding to common.

4. The accelerometer of claim 3, wherein a first cable wire is soldered to the first sensor wire, a second cable wire is soldered to the second sensor wire, a third cable wire is soldered to the third sensor wire, and a fourth cable wire is soldered to the fourth sensor wire.

5. The accelerometer of claim 1, wherein the metal cable sheath is welded to the hoot.

6. The accelerometer of claim 5, wherein the weld is a tig weld.

7. The accelerometer of claim 5, wherein the weld is a laser weld.

8. The accelerometer of claim 1, wherein the metal sheath is connected to the boot with an adhesive sealant.

9. A transducer assembly for a rotary machine, the transducer assembly comprising:
a housing positioned proximately of a bearing within the rotary machine;
a metal sheath connected to the housing to form a sealed enclosure;
a transducer within the housing; and
at least one wire extending from the metal sheath d electrically connected to the transducer,
wherein the sheath comprises a metal oxide powder insulating the at least one wire.

10. A method of providing a sealed enclosure for an accelerometer, the method comprising:
providing a metal housing with a metal boot extension;
positioning at least one of an integrated piezoelectric acceleration sensor and an integrated electronic piezoelectric (IEPE) amplified acceleration sensor within the housing such that a plurality of wires extending from the at least one sensor extends out of the metal boot extension;
positioning a metal sheath having a plurality of wires insulated by a metal oxide powder such that the wires extend from an end of the sheath to the plurality of wires extending from the sensor;
electrically connecting the plurality of wires extending from the at least one sensor to the plurality of wires extending from the boot;
positioning the electrically connected wires within the metal boot extension; and
connecting the metal sheath to the boot thereby providing a sealed enclosure for the at least one sensor, the plurality of sensor wires and the plurality of cable wires.

11. The method of claim 10, wherein the plurality of wires comprise four wires.

12. The method of claim 10, wherein the plurality of sensor wires comprise four wires, a first sensor wire carrying a signal corresponding to a first axis, a second sensor wire carrying a signal corresponding to a second axis, a third sensor wire carrying a signal corresponding to a third axis and a fourth sensor wire corresponding to common.

13. The method of claim 12, wherein a first cable wire is soldered to the first sensor wire, a second cable wire is soldered to the second sensor wire, a third cable wire is soldered to the third sensor wire, and a fourth cable wire is soldered to the fourth sensor wire.

14. The method of claim 10, wherein the metal cable sheath is welded to the boot.

15. The method of claim 14, wherein the weld is a tig weld.

16. The method of claim 14, wherein the weld is a laser weld.

17. method of claim 10, wherein the metal sheath is connected to the boot with an adhesive sealant.

18. The transducer assembly of claim 9, wherein the at least one wire comprises four cable wires.

19. The transducer assembly of claim 9, wherein the plurality of wires comprise four sensor wires, a first sensor wire carrying a signal corresponding to a first axis, a second sensor wire carrying a signal corresponding to a second axis, a third sensor wire carrying a signal corresponding to a third axis and a fourth sensor wire corresponding to common.

20. The transducer assembly of claim 9, wherein a first cable wire is soldered to the first sensor wire, a second cable wire is soldered to the second sensor wire, a third cable wire is soldered to the third sensor wire, and-a fourth cable wire is soldered to the fourth sensor wire.
